(19) United States
(12) Patent Application Publication
(10) Pub. No.: US 2007/0008894 A1
(43) Pub. Date: Jan. 11, 2007

(54) Telecommunications-based link monitoring system

(75) Inventors: Thomas J. Lynch, Newark, NJ (US); Eva Flemming, Newark, NJ (US); Leo Eckstien, Newark, NJ (US); Kara Bernatowicz, Newark, NJ (US); Sergey Aleynikov, Newark, NJ (US); Jerome Relis, Newark, NJ (US); Zev Tyberg, Newark, NJ (US); Harry Zupnik, Newark, NJ (US); Avi Stokar, Newark, NJ (US)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 11/024,672

(22) Filed: Dec. 30, 2004

Related U.S. Application Data
(60) Provisional application No. 60/619,775, filed on Oct. 19, 2004.

(51) Int. Cl. H04J 1/16; H04J 3/14

(52) U.S. Cl. 370/244; 370/252

(57) ABSTRACT

According to one embodiment of the present invention, a first automated system monitors at least one call characteristic (e.g., frequency of abnormally short calls) to determine whether quality of service standards are being met by the various carriers being utilized by the system. Such an at least one call characteristic can be stored in a database for later retrieval by an automated link diagnosis system. If appropriate, a link re-routing system can respond to an analysis of the link diagnosis system in order to re-route calls—by either taking at least one link out of service or by placing at least one link back into service.

### BACKGROUND OF THE INVENTION

1. Field of the Invention

The present invention is directed to an automatic telecommunications-based link monitoring system, and in at least one embodiment to a system for measuring and responding to problems in quality of service in a telephony environment.

2. Discussion of the Background

Known telecommunications systems can utilize varying long-haul communications providers (e.g., carriers or links) when routing a telephone call from an originating point to a destination point. Such systems may include routing preferences based on cost to the telecommunications provider, for example, in order to maximize the telecommunications provider's profit on any given call. At any given time, a carrier may experience difficulties with quality of service (QOS). Poor quality of service is an issue that causes clients to become dissatisfied with the telecommunication provider's service. Thus, known systems utilize manual routing changes in response to customer complaints about quality in order to remove underperforming links from service to avoid further quality issues. However, manual routing analyses and changes are cumbersome and are often time- or labor-intensive.

### SUMMARY OF THE INVENTION

It is an object of the present invention to provide automated analysis and routing changes in a telecommunications environment, and in at least one embodiment in a voice communications environment.

According to one embodiment of the present invention, a first automated system monitors at least one call characteristic (e.g., frequency of abnormally short calls) to determine whether quality of service standards are being met by the various carriers being utilized by the system. Such an at least one call characteristic can be stored in a database for later retrieval by an automated link diagnosis system. If appropriate, a link re-routing system can respond to an analysis of the link diagnosis system in order to re-route calls—by either taking at least one link out of service or by placing at least one link back into service.

Another aspect of the present invention provides a method for supervising at least one link, the method including: monitoring at least one characteristic of the at least one link; comparing a result of the monitoring to a predetermined threshold; and removing the at least one link from use when the comparing indicates failure of the at least one link.

Yet another aspect of the present invention includes a system for supervising at least one link, the system including: means for monitoring at least one characteristic of the at least one link; means for comparing an output of the means for monitoring to a predetermined threshold; and a controller configured to remove the at least one link from use when an output of the means for comparing indicates failure of the at least one link.

An additional embodiment of the present invention provides a system for monitoring at least one link, the system including: a database containing information related to at least one link; a search engine configured to search the database for information indicating failure of the at least one link; and a signal to indicate the failure of the at least one link.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where:

FIG. 1 is a block diagram of a telecommunications-based link monitoring system according to one embodiment of the present invention;

FIG. 2 is a flowchart showing a quality analysis determination method according to one aspect of the present invention;

FIG. 3 is a flowchart showing a link re-introduction method according to one aspect of the present invention;

FIG. 4 is a schematic illustration of a computer for implementing at least one of the automatic components of FIG. 1;

FIG. 5 is an illustration of the iterative monitoring of one aspect of the present invention;

FIG. 6 illustrates a testing configuration according to one aspect of the present invention;

FIG. 7 illustrates a report generated according to an aspect of the present invention; and

FIG. 8 represents a non-limiting method of link monitoring according to one aspect of the present invention.

### DETAILED DESCRIPTION OF THE PREFERRED EMBODIMENTS

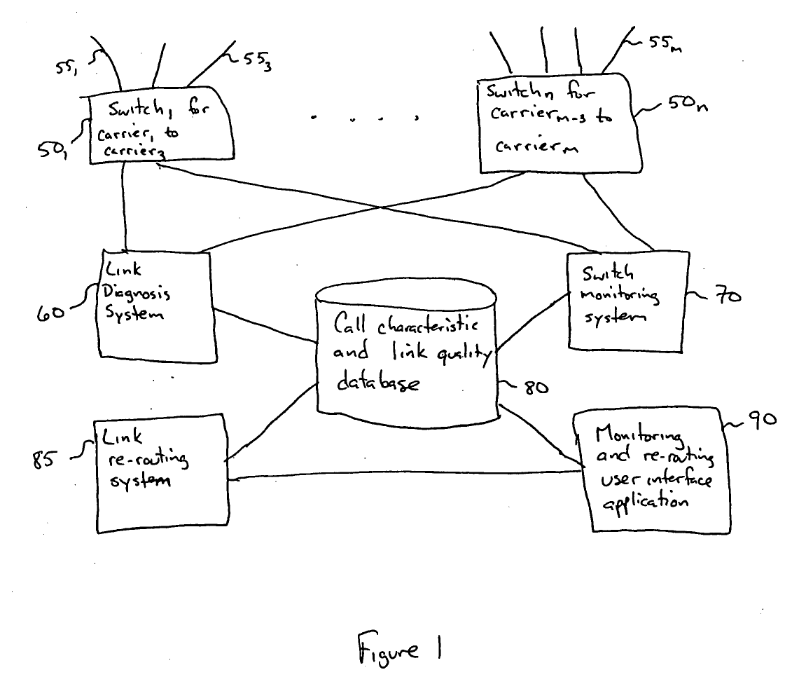

A first exemplary embodiment of a system according to the present invention is described hereinafter with respect to FIG. 1. However, the division of the components therein is strictly for illustrative purposes, and any one or a combination of the elements 60-90 therein can be combined into a single unit, as would be appreciated by one of ordinary skill in the art. Moreover, the elements may be distributed remotely from one another and communicate by means of either circuit-switched, packet-switched or hybrid communications systems.

As illustrated in FIG. 1, a telecommunications provider (e.g., a provider of circuit-switched or packet-switched telecommunications services such as voice services) utilizes a variety of switches 50₁ to 50ₙ to control communications over a series of communications links 55₁ to 55ₘ, where m is typically greater than n. As calls are established and/or terminated through the switches 50₁ to 50ₙ, the switches 50₁ to 50ₙ send messages to the switch monitoring system 70. This enables the switch monitoring system 70 to determine at least one call characteristic for each of the communications links 55₁ to 55ₘ (As shown, the number of carriers per switch may be varied across the switches, and the number of lines per carrier may also be other than the single line per carrier illustrated.)

The present invention may also monitor link performance at the switch using statistical data accumulated from a collection, normalization, or aggregation of call detail records. Data collected from the link monitoring system may be “joined” (e.g. mathematically compared) with thresholds using databases.

One such call characteristic is average length of call (ALOC) (discussed in more detail below). A high frequency of calls having very short duration (e.g., calls under 20 seconds or some other specified threshold) across a link may be identified. (A high occurrence of such short calls on a single link may be indicative of poor quality of service over the corresponding link.) Information concerning the call characteristic is stored in a database 80. (While the call characteristic and link quality database 80 is shown as a single database, it is to be understood that multiple databases may instead be utilized to hold that information.) The link re-routing system 85 can then read information on the call characteristics of the links 55₁ to 55ₘ to determine if the quality of service of at least one link has become an issue. If the quality of service is an issue, the link re-routing system 85 can take the corresponding link out of service until the problem is resolved.

According to one non-limiting aspect of the present invention, it is possible to manually or automatically determine the thresholds. One method of determining the threshold automatically includes using historical time of day average call completion ratios (CCR's) and ALOCs to a particular location, switch, division, or other unit. Other factors, such as day of week or type of day (such as a holiday, for example) may also be used to determine the appropriate threshold.

These historical averages may be adjusted up or down based on a desired level of quality of service (QOS). For example, for a first level of QOS, the threshold may be at least 5% above average, while a second level of QOS may require performance at 10% below average. The QOS variations may be based on a number of statistical measures.

Additionally, the historical time of day thresholds may be adjusted by current day fluctuations in QOS. Different times of day have different QOS due to differing levels of traffic and varying patterns of traffic. As one non-limiting aspect of the present invention, QOS may be averaged for a four hour window (e.g., 2 pm-6 pm) over a four week period. If, for instance, the QOS was 10% higher than average for the four hour window of 2 pm-6 pm, then the expected QOS for the 6 pm-10 pm window could be adjusted to be 10% higher than the four week average for that time period. Through this QOS fluctuation adjustment, it is possible to obtain the highest quality carrier available, without drastically altering the thresholds applied.

After a link has been taken out of service, a link diagnosis system 60 may periodically check the removed link to determine if the quality of service issue has been resolved. Information on the results of those checks can be either written to the database 80 or communicated directly to the link re-routing system 85. When the link re-routing system 85 determines that a link should be re-introduced, it re-introduces the link and monitors at least one call characteristic to determine if the link should remain in service.

The monitoring and re-routing user interface application 90 allows a systems operator to determine at least one call characteristic for each of the links and determine which links are currently out of service. Moreover, the application 90 allows the systems operator to manually take out of service or re-introduce into service any of the links 55₁ to 55ₘ.

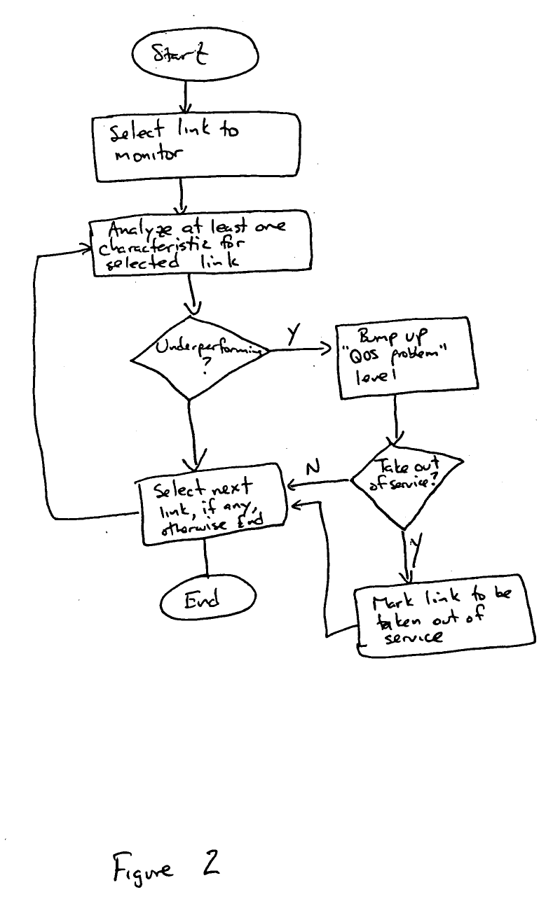

As illustrated in FIG. 2, the link diagnosis system 60 selects each of the links monitored by the monitoring system 70 and analyzes (e.g., by accessing the database 80) at least one characteristic for the selected link. For example, the link diagnosis system 60 selects the link 55₁ and determines that the number of short calls on this first link is less than a specified threshold (e.g., less than 20 in the last hour or less than 5% of all calls in the last hour). If the link diagnosis system 60 determines that the link is underperforming, then the system 60 bumps up the QOS problem level to the next level. If the new QOS problem level is above a pre-defined system-wide or link-specific threshold, then the link is marked to be taken out of service or is taken out of service directly. In an embodiment that simply marks the link to be taken out of service, the link can be taken out by either a periodically running process or by manual acceptance of the link removal notice by a system operator. If there are other links monitored by the system that have not been checked, then those links are also checked.

While the above-description was given in terms of all the links being checked at once in series, the system may also specify a link-by-link or carrier-by-carrier time at which the checking should be performed. In such an embodiment, only the links specified as needing checking at the current time are checked. In this way, some of the links can be checked more often than others. This provides the benefit that if certain time periods are known to cause false removal notifications on particular links, the tests on those links at those times can be selected not to run such that the link is not unnecessarily pulled from the system. Moreover, the test for “underperforming” need not be the same for all links and in fact can change for a single link depending on the time-of-day or the day of the week. Certain links may require higher quality of service than others, so different thresholds and different QOS problem levels may be applied to different links. Additionally, different thresholds and different QOS problem levels may be applied to the same link at different times.

In addition, in an alternate embodiment, instead of the underperforming links be marked to be taken out of service, they may instead or in addition be placed on a watch list after reaching a particular threshold. For example, if the normal operating level is level 1, and a link has reached a level 3 problem, it may be placed on a watch list such that the system operator knows that a problem may be developing. If that link continues to have problems, eventually arriving at a level 5, the link may nonetheless be marked as a candidate for removal even if the operator has taken no action.

There are several ways of determining that a link, such as a trunk line, is not functioning optimally or at a desired level. One such method is ALOC, described briefly above. In regular practice, the average length of a call indicates voice quality, because when link quality is poor, one of the calling parties usually disconnects and retries the call. Thus, calls made on links with poor quality tend to be very short (e.g., on the order of one minute).

Another method is through customer complaints, which are generally of two forms. The first customer complaint is typically that the connection quality was poor. The second form of customer complaint is that he could not make a connection to the called party.

Two additional methods of problem detection on trunk lines are average seizure ratio (ASR) and call completion ratio (CCR). ASR and CCR monitor the caller's ability to make a connection to the called party. By monitoring ASR, CCR, and ALOC, which reflect the length of the call—and indirectly reflect trunk line quality—it is possible to determine if a link has a problem.

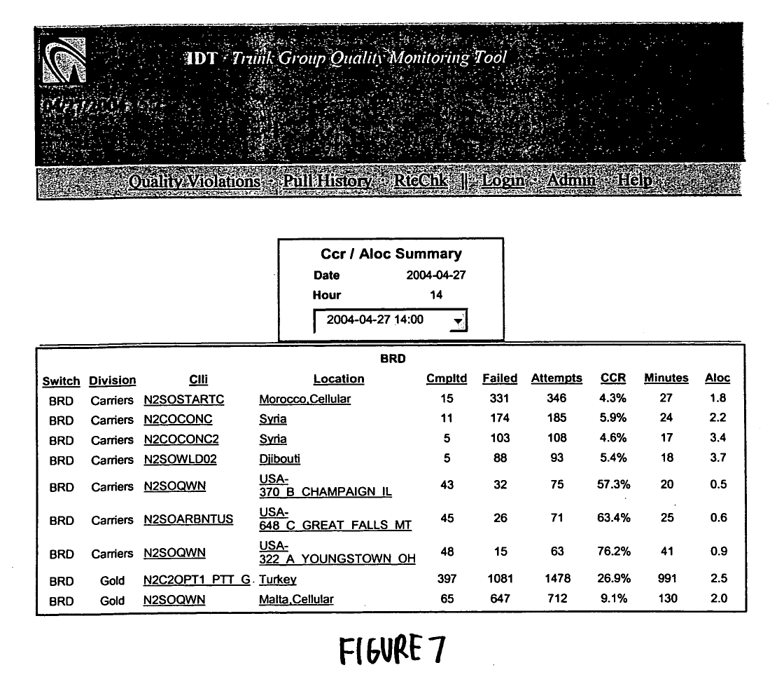

FIG. 7 represents a non-limiting example of a report that may be generated to show carrier or link performance. As illustrated in FIG. 7, the report indicates which switch is the subject of the report, as well as what level of service is desired (gold, silver . . . ). The routing location is also provided. The report further provides detailed information on the monitoring factors described above, such as the number of calls completed, the number of failed calls, the number of attempted calls, CCR, total minutes of use, and ALOC.

Another method of detecting line problems is through listening tools or probes. These listening tools or probes typically check for noise, jitter, and echo, as well as other problems known to those of skill in the art.

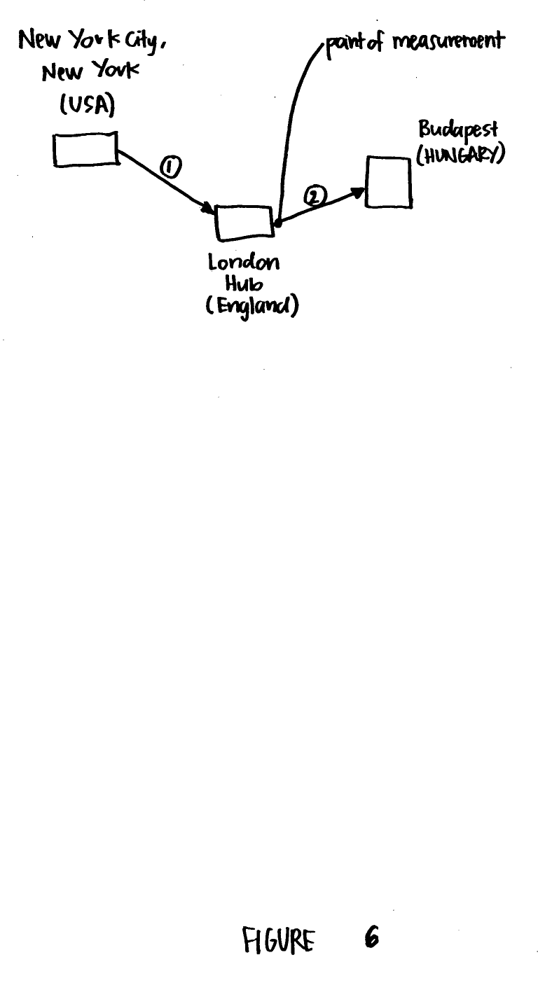

These quality measurements occur at the outgoing call switch point, as illustrated in FIG. 6. As the non-limiting example of FIG. 6 shows, a call may be initiated from New York City, in the United States. The call endpoint may be Budapest, Hungary. To get the call through to Hungary, it may be switched through a London interchange and carried by a third party carrier to the endpoint. Assuming that the London interchange is owned, operated, or otherwise accessible by the carrier originating the call in New York City, call quality may be monitored by the originating carrier as it departs the London interchange switch. This monitoring technique enables the originating carrier to determine the quality of signal provided to the third party carrier. Thus, if any of the ASR, CCR, or ALOC (or other factors known to those of skill in the art) indicate that callers using this route experienced undesirable call characteristics such as noise or failure to connect, it is possible for the originating carrier to determine the source of such a problem. Since the signal is measured at the time it departs the originating telecommunication provider's network, the provider can determine the quality on the third party carrier's link. If the third party's call quality does not satisfy the provider's particular requirements, the carrier may be removed from circulation.

It is also possible to remove a carrier only with respect to a particular destination. For example, if the system of the present invention detects that a particular carrier's service is inadequate for calls made to Budapest, calls to Budapest may be routed through another carrier. At the same time, calls to London may still be routed over that particular carrier's trunk lines (assuming that the carrier's level of service is sufficient for calls to London).

Based on the results of monitoring the links, it is possible to pull a link or a carrier from routing. However, even when a link or a carrier is pulled from circulation for one purpose, it may remain in use for another type of service.

For example, an originating telecommunication provider may have a number of different levels of service. The levels of service may be differentiated based on a number of factors. These factors may include, but are not limited to: price per call, price per minute, minimum number of minutes, relative importance of call completion, type of customer (e.g., business enterprise, residential, debit card, or carrier, among others), as well as other factors known to those of skill in the art (hereafter “business rules”). The highest level of service may represent a service where the business rules mandate that call connection be guaranteed to the user (e.g., “gold”). Thus, at this level of service, the maximum acceptable call failure rate may be, for example, 5%. By contrast, an acceptable rate of failure for customers of a lower level of service may be 20%. Therefore, a link or third party carrier that fails at an unacceptable rate for a high level of service may still be used for a lower level of service (e.g., “silver”), according to the business rules.

Despite the overall utility of the above-identified error measurements, it is possible that these characteristics may give a false link failure indication. For example, in times of tragedy or great excitement (such as the World Trade Center attacks of Sep. 11, 2001 or the Madrid Train Bombing of 2004, hereafter “exception times”), carriers may observe very poor ASR or CCR. In the ordinary course of business, a high volume of calls through a link with low ASR and/or CCR would indicate failure of the line or carrier. However, during exception times, the lines and/or carriers may not actually be failing. Thus, it is important to account for the exception times.

To account for the exception times, according to one non-limiting aspect of the present invention, an override feature is provided. To this end, if a trunk line or carrier failure is detected, it is possible for the system to review current events to determine the presence or absence of an exception time. If an exception time is found to exist, it is possible to override a command to pull a link from service.

False answer supervision is another problem that can be addressed by the present invention. False answer supervision occurs when a carrier falsely indicates acceptance and completion of a call, and frequently occurs for calls made to cellular customers. Calls resulting from false answer supervision have a very high CCR with a very short ALOC.

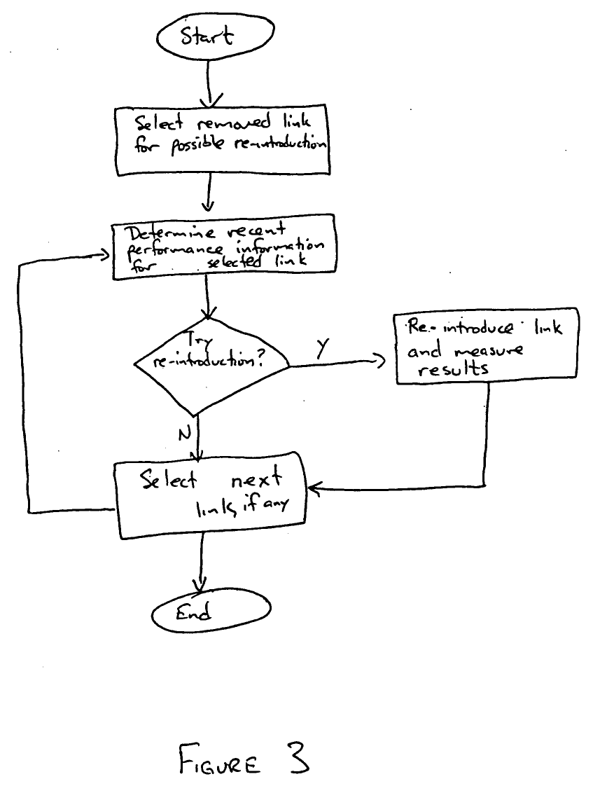

FIG. 3 illustrates a flowchart providing one method of re-introducing links that were previously taken out of service. According to this embodiment, a link diagnosis system 60 is assumed to have been collecting (and storing into the database 80) information on the links that were previously taken out of service to determine their quality of service. Such checks may be performed by any number of methods, including, but not limited to, initiating outbound calls over the links that were experiencing trouble; checking a web site, e-mail account or other information service corresponding to the carrier experiencing the problem to see if the carrier has reported that the link has been fixed; and determining if a system operator has cleared the error corresponding to the link. Other methods of error resolution known to those of skill in the art are also encompassed herein.

If the link re-routing system 85 determines that the information gathered by the link diagnosis system 60 (and either communicated directly from the link diagnosis system 60 or stored in the database 80) indicates that the previously removed link is now operating acceptably, then the link re-routing system 85 re-introduces the link and its call characteristics are again monitored. The process is then repeated for any remaining links that have been taken out of service.

In one embodiment of the present invention, when a link is taken out of service, as in FIG. 2, the link re-routing system 85 automatically sends a notification to the carrier responsible for the link (e.g., via text messaging, e-mail, voice messaging, or other methods known to those of skill in the art) and records the time at which the notification was sent. In such an embodiment, the determination of recent performance information for the corresponding link may simply be the expiration of a particular time period (e.g., a threshold time such as 48 hours). This period can be set on a link-by-link basis based on experience or agreements with the carrier on how quickly problems are to be resolved.

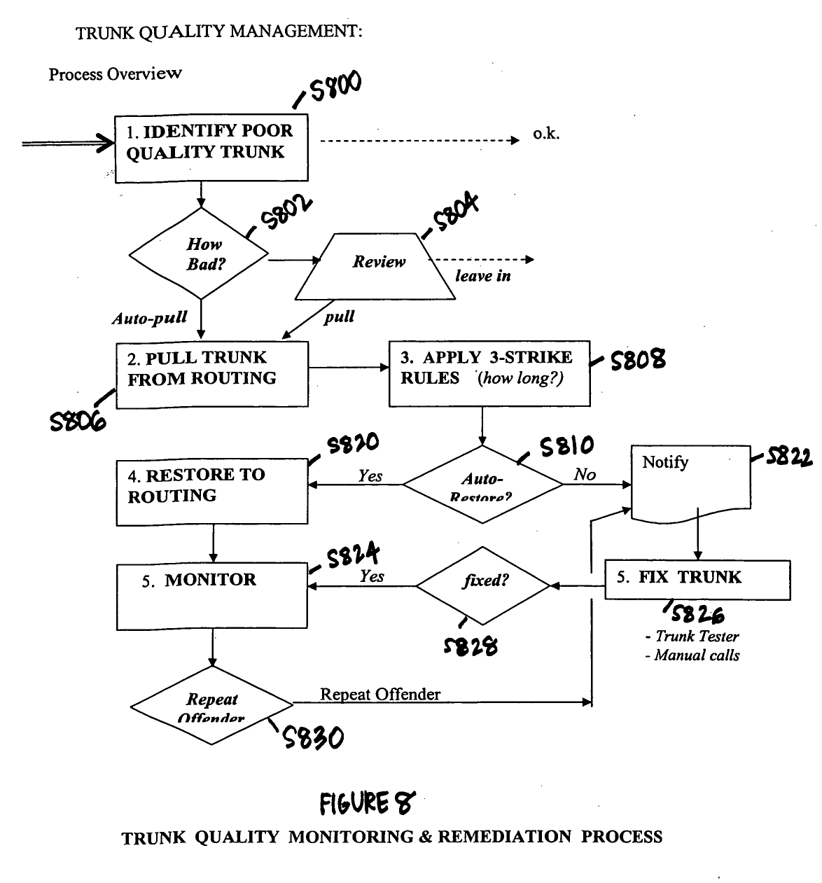

FIG. 8 illustrates another non-limiting example of a method of link quality according to the present invention. In step S800, poor trunk quality is identified. In step S802, the level of poor quality is assessed. If the level of poor quality meets a certain threshold, the link is sent for review. The review occurs in step S804, wherein an analyst or automated function may choose to allow the link to remain in service. If the link quality is indicated to be of an unacceptable level, the link may be pulled from routing. This pulling in step S806 may occur through an auto pull or pull after review function. In step S808 three strike rules may be applied (discussed infra). Depending on the outcome of step S808, the length may be restored in step S820. Alternatively, if the auto restore function is not activated in step S810, in step S822 the carrier responsible for the faulty link is notified. Subsequently, the link is fixed in step S826 and if step S828 determines that the trunk has indeed been successfully fixed, the trunk is returned to active use and monitoring in step S824. If the auto restore function is activated in step S810, the link is restored to routing in step S820 and returned to monitoring in step S824. In step S830, the link is examined to determine if it is a repeat offender. If the link is determined to be a repeat offender in step S830, the carrier responsible for the unsatisfactory link is notified in step S822, and the process repeats as indicated in FIG. 8.

In the context of utilizing experience, the system may be programmed to be self-adapting. For example, the system may be programmed to try to re-introduce a link after an initial period and then monitor the characteristic after this re-introduction. If the system determines that the link is then removed again within a specified period of time, the system may automatically increase the time the system waits before re-introducing the link again. For example, if a selected link that is initially put back into service after 24 hours is always taken out of service again within 5 hours, then the system will learn to only put that link back into service after an additional 12 hours (i.e., at 36 hours) the next time it is taken out of service. This addition of time can be an iterative process as the system determines that the link is still being taken out of service again quickly after being put back in service on a first attempt. This iterative learning process may be applied on a link by link basis, a third party carrier basis, or system wide, for example.

Similarly, the system can try to automatically shorten the time that a link is kept out of service if the corresponding link operates correctly X percent of the time when put back into service within the initially or currently specified time. For example, if the link is re-introduced only after 36 hours (e.g., because the link was initially failing at a 24 hour re-introduction), and that re-introduction in 36 hours is successful 95% of the time after 20 times, then the system may reduce the re-introduction time back down to 24 hours or to the mid-point between the last failing point and the last succeeding point (i.e., (24+36)/2=30 hours). The system can likewise be programmed with maximum and minimum re-introduction times. These examples are intended to be illustrative only, and not limiting of the present invention.

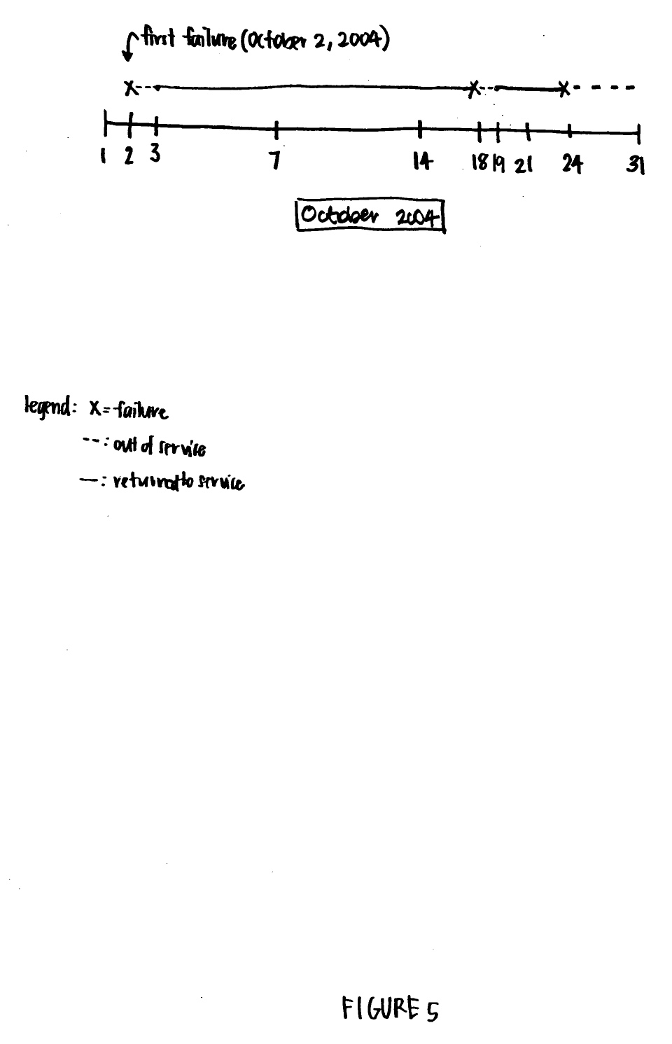

Another non-limiting example of one iterative process of the present invention is illustrated in FIG. 5. FIG. 5 illustrates a moving window that may be used to determine an unacceptable number of failures within a given time period. In the non-limiting example of FIG. 5, an undesirable failure time window is set as three failures within 21 days. In the example of FIG. 5, a first failure occurs on Oct. 2, 2004. At this time, the carrier is pulled from service for a 24-hour period of time. This link becomes available for use again on Oct. 3, 2004. The line remains successfully in use until Oct. 18, 2004, when another failure occurs. At the time of the second failure, it is possible to analyze the link failure in a smaller window. For example, if the failure had occurred on Oct. 7, 2004, which is within seven days after the first failure, an originating carrier may choose to remove the link for service for a duration of 72 hours. In the example of FIG. 5, however, the failure occurs on Oct. 18, 2004. In this example, October 18 is after the narrower internal window for two failures. Thus, on Oct. 18, 2004, the carrier is removed from service for 24 hours again (since this second failure is effectively treated as a first failure). This link is then returned to service on October 19. A third failure subsequently occurs on Oct. 24, 2004. Using a larger window, three failures will have occurred within 30 days. In this example, three failures within 30 days is considered an unacceptable failure rate. Thus, on Oct. 24, 2004, this link may be removed from service until the link has been proven reliable again by one of the methods described above. The time frames used in this example are not intended to be limiting, but merely illustrative of a non-limiting method of link monitoring according to the present invention.

As a non-limiting example of the tracking features of the present invention, it is possible to use statistics as the basis for which decisions are made to pull or re-introduce a link or carrier. The statistics used to make these decisions may be varied by margin of error. For example, assume a particular customer requires a call completion rate of 75%. If 56 out of 80 calls have been completed, the link indicates a completion rate of 70%. However, using the margin of error statistical method, this link may be pulled for review, rather than pulled from service. When 56 out of 80 calls have been completed, it is possible to achieve a 76% completion rate, which is higher than the 75% completion rate required by the client. It is advantageous not to pull the link too early, because the originating provider may be forced to use a link that is more expensive to that provider (causing a reduction in profits). Thus, it is possible to minimize costs related to link service by avoiding premature link removal.

As another non-limiting example, assume that a particular client has a 40% call completion requirement. If a link or carrier provides a 10% completion rate, it is possible to automatically pull that carrier after one hour of bad service. By contrast, if that carrier or link is providing a 25% completion rate, it is possible to review the link or carrier based on other factors to determine if the link could possibly achieve the 40% requirement. In one non-limiting example, an analyst may choose if the carrier or link should be pulled from circulation.

Thus, as these examples indicate, it is possible to have a range of call completion rates that result in an automatic pulling of the carrier or link. It is also possible to create a range of call completion rates suitable for review. If a particular link or carrier appears in the review list for more than one hour, it is also possible to apply statistics to have the carrier or link pulled from circulation.

As noted above, when a carrier or link is pulled from circulation, the carrier or link may be pulled for only a certain service group. However, certain carriers or links may be the only route for every level of service. For example, in the United States, there is a single set of routes in a routing table. If a pull command directs removal of a particular carrier or link from routing to Washington, D.C. for a particular level of service, every customer in the United States may be relying on that carrier for every level of service. In this case, pulling that carrier from use in a particular service has no effect, because there is only one route and that level of service may be piggybacked upon the primary route. To prevent such an occurrence, it is possible to generate an unexpected traffic notice or report. This traffic notice indicates that the carrier or link removal command has failed. In response to this report, routing analysts may monitor the report and may take remedial action. In order to put the removal command into effect, it is possible to pull the carrier or link for all levels of service. Thus, the service problem is corrected. While this example relies upon the expertise of analysts, it is possible to automate this feature.

The reports generated by the monitoring system and the re-introduction or removal rules applied to links and carriers may be further modified based on information about a particular time of day, a particular day of the week, or a particular holiday. For example, certain times on Christmas day may historically have provided higher or lower levels of call traffic. The present invention may account for the historical call traffic information (as well as for other types of historical information) and may modify the re-introduction or removal rules, as necessary.

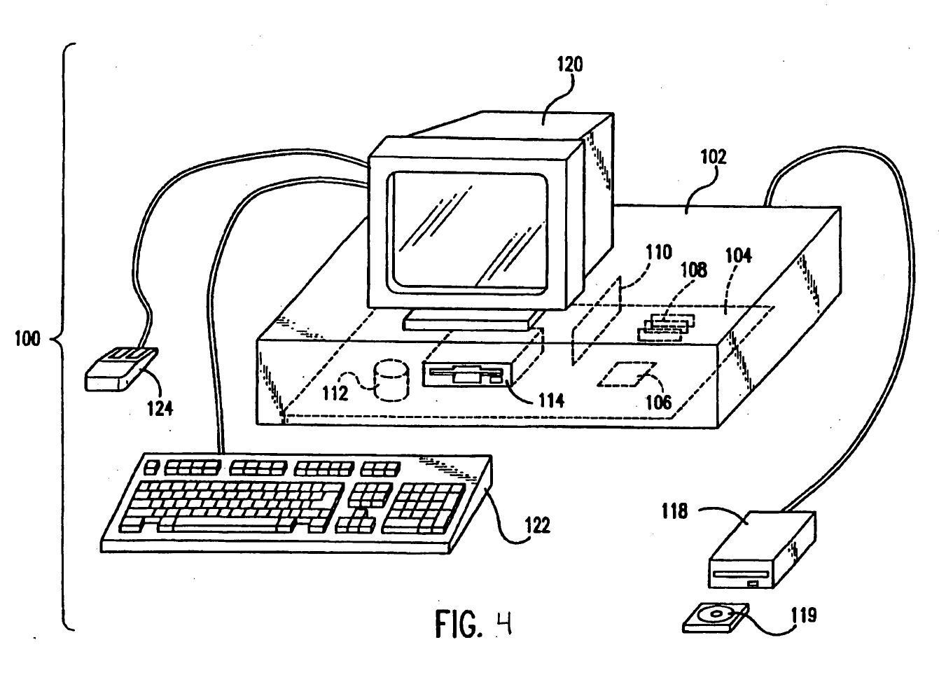

FIG. 4 is a schematic illustration of a computer system for performing at least one of the functions of FIG. 1. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of link statuses.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Together, the computer readable media and the software thereon form a computer program product of the present invention for performing at least one of the functions of FIG. 1. The computer code devices of the present invention can be any interpreted or executable code mechanism, including but not limited to scripts, interpreters, dynamic link libraries, Java classes, and complete executable programs. For example, the application 90 may be a web interface that queries the database 80 and/or controls one of the switches 50₁ to 50ₙ.

The present invention may also use a web application server, which implements a user interface. A database server including information for comparing actual link performance with thresholds, as well as network databases that aggregate and process the link performance data. The present invention may further include an interface between the link monitoring system and a business rules database or engine, to aid the system in determining compliance with the predetermined business rules. The web application server may be connected (e.g., via a local area network (LAN) or other suitable architecture) to operator consoles that enable execution of the method of the present invention.

Obviously, numerous modifications and variations of the present invention are possible in light of the above teachings. It is therefore to be understood that within the scope of the appended claims, the invention may be practiced otherwise than as specifically described herein.

1. A method for supervising at least one link, the method comprising:
monitoring at least one characteristic of the at least one link;
comparing a result of the monitoring to a predetermined threshold; and
removing the at least one link from use when the comparing indicates failure of the at least one link.

2. The method of claim 1, wherein the at least one characteristic includes at least one of average length of call (ALOC), call completion ratio (CCR), and average seizure ratio (ASR).

3. The method of claim 1, further comprising re-introducing the at least one link after a predetermined period of time.

4. The method of claim 3, further comprising re-introducing the at least one link after testing the at least one link.

5. The method of claim 3, wherein the predetermined period of time depends at least in part on historical re-introduction information.

6. The method of claim 1, further comprising re-introducing the at least one link after testing the at least one link.

7. The method of claim 1, wherein the predetermined threshold is based at least in part on historical information related to at least one of average call traffic per time of day, average call traffic per day of week, and average call traffic per telecommunications provider.

8. The method of claim 1, further comprising overriding the removing when an exception time is identified.

9. The method of claim 1, wherein the removing comprises removing the at least one link based at least in part on a call destination.

10. A system for supervising at least one link, the system comprising:
means for monitoring at least one characteristic of the at least one link;
means for comparing an output of the means for monitoring to a predetermined threshold; and
a controller configured to remove the at least one link from use when an output of the means for comparing indicates failure of the at least one link.

11. The system of claim 10, wherein the at least one characteristic includes at least one of average length of call (ALOC), call completion ratio (CCR), and average seizure ratio (ASR).

12. The system of claim 10, further comprising means for re-introducing the at least one link after a predetermined period of time.

13. The system of claim 12, wherein the predetermined period of time depends at least in part on historical re-introduction information.

14. The system of claim 12, further comprising means for testing the at least one link.

15. The system of claim 10, further comprising means for testing the at least one link.

16. The system of claim 15, further comprising means for re-introducing the at least one link based on an output of the means for testing.

17. The system of claim 10, further comprising means for overriding the means for removing.

18. The system of claim 10, wherein the controller is configured to remove the at least one link based at least in part on a call destination.

19. A system for monitoring at least one link, the system comprising:
a database containing information related to at least one link;
a search engine configured to search the database for information indicating failure of the at least one link; and
a signal to indicate the failure of the at least one link.

20. The system of claim 19, wherein the information indicating failure includes at least one of average length of call (ALOC), call completion ratio (CCR), and average seizure ratio (ASR).

21. The system of claim 19, further comprising a signal to indicate that the at least one link is no longer in failure.

22. The system of claim 19, wherein the search engine searches the database by joining the information related to at least one link with threshold information.
